(19) United States
(12) Patent Application Publication
(10) Pub. No.: US 2019/0275841 A1
(43) Pub. Date: Sep. 12, 2019

(54) TIRE WITH EVOLVING TREAD

(71) Applicant: Bridgestone Americas Tire Operations, LLC, Nashville, TN (US)

(72) Inventor: Jon I. Stuckey, Uniontown, OH (US)

(21) Appl. No.: 16/288,989

(22) Filed: Feb. 28, 2019

Related U.S. Application Data
(60) Provisional application No. 62/639,611, filed on Mar. 7, 2018.

(51) Int. Cl. B60C 11/00; B60C 1/00

(52) U.S. Cl. CPC B60C 11/005; B60C 2011/0025; B60C 11/0008; B60C 1/0016

(57) ABSTRACT

A tire includes a circumferential tread having a base layer and a cap layer disposed above the base layer. The base layer is constructed of a first material having a first complex dynamic modulus and a first glass transition temperature, and the cap layer is constructed of a second material having a second complex dynamic modulus greater than the first complex dynamic modulus and a second glass transition temperature higher than the first glass transition temperature. The base layer has a shaped geometry with a bottom portion that is wider than a top portion, such that an exposed surface area of the first material increases as the circumferential tread wears.

### FIELD OF INVENTION

This disclosure relates to the field of tires with circumferential treads. More specifically, this disclosure relates to the field of tires with circumferential treads constructed of multiple materials having different material properties.

### BACKGROUND

Tire treads are rubber compositions which contain at least some carbon black reinforcement. The rubber of a tread may be selected for its material properties, such as its hardness. As the tread wears, the tread rubber maintains the same material properties. Multi-layered tread structures have also been employed for durability purposes and to improve abrasion resistance or wet-road properties.

### SUMMARY OF THE INVENTION

In one embodiment, a tire includes a tread having a plurality of grooves. The tread has a base layer and a cap layer disposed above the base layer. The base layer is constructed of a first rubber composition having a first complex dynamic modulus, and the cap layer is constructed of a second rubber composition having a second complex dynamic modulus greater than the first complex dynamic modulus. The base layer has a shaped geometry with a bottom portion that is wider than a top portion. A portion of the base layer is exposed when the tire is new, such that

$$\frac{{S}_{1}}{{S}_{2}} > 0 ,$$

where S₁ is a surface area of the first rubber composition, and S₂ is a surface area of the second rubber composition. Additionally,

$$\frac{{S}_{1}}{{S}_{2}}$$

increases as the tread wears.

In another embodiment, a tire includes a circumferential tread having a base layer and a cap layer disposed above the base layer. The base layer is constructed of a first material having a first complex dynamic modulus and a first glass transition temperature, and the cap layer is constructed of a second material having a second complex dynamic modulus greater than the first complex dynamic modulus and a second glass transition temperature higher than the first glass transition temperature. The base layer has a shaped geometry with a bottom portion that is wider than a top portion, such that an exposed surface area of the first material increases as the circumferential tread wears.

In yet another embodiment, a tire tread includes a base layer constructed of a first material having a first complex dynamic modulus, a first glass transition temperature, and a first resistivity. The tire tread also has a cap layer constructed of a second material having a second complex dynamic modulus, a second glass transition temperature, and a second resistivity. The tire tread further includes at least one antenna constructed of a third material having a third complex dynamic modulus, a third glass transition temperature, and a third resistivity. The first complex dynamic modulus is less than the second complex dynamic modulus, and the first glass transition temperature is lower than the second glass transition temperature. The first resistivity is higher than the third resistivity, and the second resistivity is higher than the third resistivity.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a perspective view of one embodiment of a tire 100 having a multi-layered tread;

FIG. 2 is a partial cross-section of the tire 100;

FIG. 3 is a partial cross-section of an alternative embodiment of a tire having a multi-layered tread;

FIG. 4 is a partial cross-section of another alternative embodiment of a tire having a multi-layered tread; and

FIG. 5 is a partial cross-section of yet another alternative embodiment of a tire having a multi-layered tread.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Circumferential” and “circumferentially” refer to a direction extending along the perimeter of the surface of the tread perpendicular to the axial direction.

“Equatorial plane” refers to the plane that is perpendicular to the tire's axis of rotation and passes through the center of the tire's tread.

“Radial” and “radially” refer to a direction perpendicular to the axis of rotation of a tire.

“Tread” as used herein, refers to that portion of the tire that comes into contact with the road or ground under normal inflation and load.

Directions are stated herein with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” or “top” and “bottom” are used in connection with an element, the “upper” or “top” element is spaced closer to the tread than the “lower” or “bottom” element. Additionally, when relative directional terms such as “above” or “below” are used in connection with an element, an element that is “above” another element is closer to the tread than the other element.

The terms “inward” and “inwardly” refer to a general direction towards the equatorial plane of the tire, whereas “outward” and “outwardly” refer to a general direction away from the equatorial plane of the tire and towards the sidewall of the tire. Thus, when relative directional terms such as “inner” and “outer” are used in connection with an element, the “inner” element is spaced closer to the equatorial plane of the tire than the “outer” element.

While similar terms used in the following descriptions describe common tire components, it is understood that because the terms carry slightly different connotations, one of ordinary skill in the art would not consider any one of the following terms to be purely interchangeable with another term used to describe a common tire component.

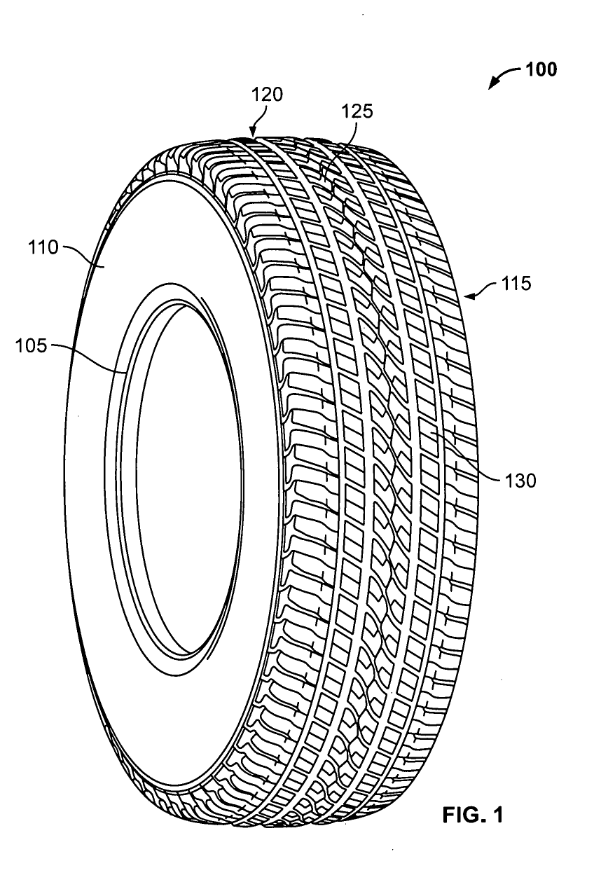

FIG. 1 is a perspective view of one embodiment of a tire 100. The tire 100 is a pneumatic tire having a pair of bead portions 105 and a pair of sidewall portions 110 extending between the pair of bead portions 105 and a circumferential tread 115. Only one bead portion and one sidewall is visible from this view. In the illustrated embodiment, the circumferential tread 115 includes four circumferential grooves 120 that define five circumferential ribs 125. Each rib 125 is further divided into a plurality of blocks 130 by a plurality of lateral grooves.

In alternative embodiments (not shown), the tread may have more than five ribs. In another alternative embodiment, the tread may have four or fewer ribs. One or more of the ribs may be circumferentially continuous (i.e., lacking lateral grooves). The tread may include any number of sipes or other tread elements.

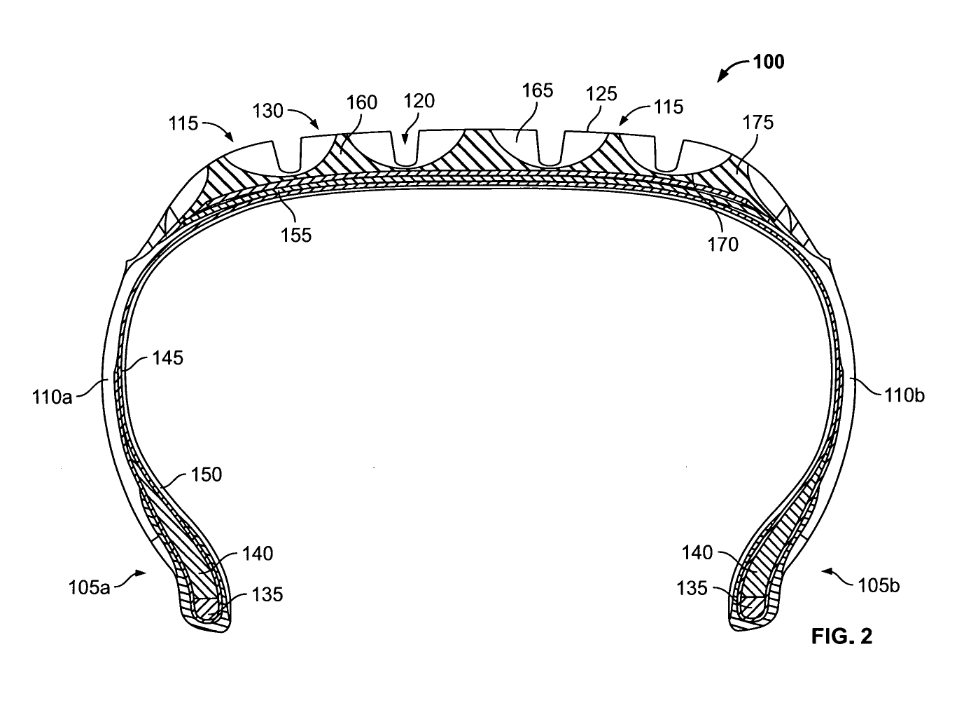

FIG. 2 is a partial cross-section of the tire 100. From this view, it can be seen that the pair of bead portions 105 includes a first bead portion 105a and a second bead portion 105b, and the pair of sidewalls 110 includes a first sidewall 110a and a second sidewall 110b. Each bead portion includes a bead 135 and a bead filler 140. In alternative embodiments (not shown), the bead filler may be composed of multiple components. In another alternative embodiment (not shown), the bead filler may be omitted.

A body ply 145 extends from bead to bead, wrapping around each bead 135 and having turn up portions that extend along the outside of each bead filler 140. In an alternative embodiment (not shown), the turn up portion extends along the inside of the bead filler. In another alternative embodiment, the tire may include two or more body plies.

An inner liner 150 is disposed along the inside of the body ply 145. In an alternative embodiment (not shown), the inner liner may be omitted.

A pair of belts 155 are disposed above the body ply 145. The belts may be constructed of steel or a polymeric material. In an alternative embodiment (not shown), a single belt may be employed. In another alternative embodiment, three or more belts may be employed. Additionally, the tire 100 may include cap plies or other reinforcements. Such reinforcements may be located in a crown region, a sidewall, or a bead portion.

The circumferential tread 115 is a multi-layered tread that includes a base layer 160 and a cap layer 165 disposed above the base layer 160. The base layer 160 is constructed of a first material and the cap layer 165 is constructed of a second material different from the first material. In one embodiment, the first material of the base layer 160 is a first rubber composition having a first complex dynamic modulus and a first glass transition temperature. The second material of the cap layer 165 is a second rubber composition having a second complex dynamic modulus greater than the first complex dynamic modulus, and a second glass transition temperature higher than the first glass transition temperature. Specifically, the first material has a lower glass transition temperature and a lower complex dynamic modulus than the second material when measured at −20° C., 6% static tensile strain and +/−0.2% dynamic strain. In other words, the base layer 160 is constructed of a softer and more pliable material than the cap layer 165.

Exemplary first rubber compositions for the base layer include, without limitation, natural rubber, synthetic rubber, carbon black, plasticizers, and oil. Alternatively, other materials may be employed. For example, any material having a dynamic complex modulus less than 200 mPa and a glass transition temperature less than −60° C. may be used as a base layer.

Exemplary second rubber compositions for the cap layer include, without limitation, natural rubber, synthetic rubber, carbon black, silica, and silane. Alternatively, other materials may be employed. For example, any material having a dynamic complex modulus greater than 400 mPA and a glass transition temperature greater than −50° C. may be used as a cap layer.

When a tread is constructed of a single material, the ribs and blocks are more flexible when the tire is new. As the tread wears and the groove depth decreases, the ribs and blocks become increasingly stiffer. By contrast, a multi-layered tread having a base layer constructed of a material with a lower dynamic complex modulus and a lower glass transition temperature will not become as stiff when the tire wears. The shape and the material composition of the base layer may be selected to “tune” the tire tread so that the tread maintains substantially the same stiffness as it wears. Alternatively, the tire tread may be “tuned” so that it become less stiff as it wears.

A material having a lower dynamic complex modulus and a lower glass transition temperature may exhibit better performance in cold temperatures and in snow, while a material having a higher dynamic complex modulus and a higher glass transition temperature may exhibit better performance in warm temperatures. Thus, the cap layer of the tread may have desirable properties for driving in the spring and summer seasons. Then as the tread wears and the base layer is exposed, the tread may have desirable properties for driving in the fall and winter.

In the illustrated embodiment, the base layer 160 has a shaped geometry with a bottom portion that is wider than a top portion. Here, the base layer 160 includes a single base 170 that extends laterally across the crown of the tire 100. Multiple radial projections 175 extend outwards from the single base 170. In the illustrated embodiment, each rib 130 includes a single projection 175 of the base layer 160 that extends to the surface of the tread 115 when the tire 100 is new. In other words, a portion of the base layer is exposed when the tire is new, such that:

$$\frac{{S}_{1}}{{S}_{2}} > 0$$

where S₁ is the surface area of the first rubber composition of the base layer 160, and S₂ is the surface area of the second rubber composition of the cap layer 165. The base layer 160 has a shaped geometry such that

$$\frac{{S}_{1}}{{S}_{2}}$$

increases as the tread 115 wears.

In an alternative embodiment (not shown), the base layer may have two or more projections disposed in some ribs. In another alternative embodiment (not shown), the base layer may not have any projections in some ribs. In yet another alternative embodiment (not shown), at least one rib does not contain a base layer. In still another alternative embodiment (not shown), the base layer does not extend to the surface of the tread when the tire is new.

In one embodiment, the base layer 160 is constructed of a material having a first color and the cap layer 165 is constructed of a material having a second color different from the first color. For example, the cap layer 165 may be black and the base layer 160 may be white or a bright color. Thus, the base layer 165 may serve as a wear indicator. As the tread 115 becomes increasingly colored, it provides a signal to the user that the tire 100 is worn.

The base layer 165 may also have other properties that allow it to serve as a wear indicator. In one embodiment, the base layer 160 is constructed of a material having a first reflectivity when wet and the cap layer 165 is constructed of a material having a second reflectivity when wet that is different from the first reflectivity. Thus, as the tire tread 115 becomes more reflective (or less reflective), it provides a signal to the user that the tire 100 is worn.

It should be understood that the multi-layered tread 115 described herein is not limited to any particular type of tire, or even to pneumatic tires. While a passenger tire 100 is illustrated in FIGS. 1 and 2, in other embodiments, the tire may be a truck tire, a high performance tire, or an off the road tire. In another alternative embodiment, the tire may be a run-flat tire or a non-pneumatic tire.

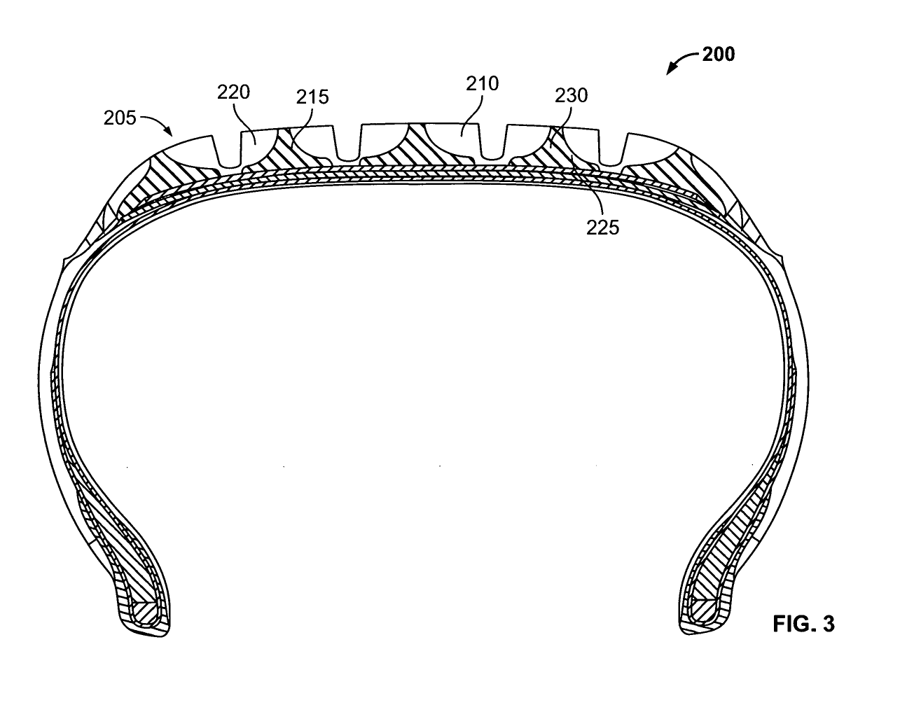

FIG. 3 is a partial cross-section of an alternative embodiment of a tire 200 having a multi-layered tread 205. The tire 200 is substantially the same as the tire 100 of FIGS. 1 and 2 and described above (including the alternative embodiments described), except for the differences discussed herein.

The tread 205 includes a plurality of ribs 210, with each rib including a base layer 215 and a cap layer 220. The base layer 215 and cap layer 220 are substantially the same as the base layer 160 and cap layer 165 discussed above.

In this embodiment, the tread 205 includes multiple base layers 215 that are axially spaced from each other. More specifically, each rib includes a base layer 215 having a discrete base 225 with a radial projection 230 extending therefrom. The projections 230 extend to a surface of the tread 205 when the tire 200 is new.

In an alternative embodiment (not shown), the base layer may have two or more projections disposed in each rib. In another alternative embodiment (not shown), the base layer may not have any projections in some ribs. In yet another alternative embodiment, at least one rib does not contain a base layer. In still another alternative embodiment (not shown), the base layer does not extend to the surface of the tread when the tire is new.

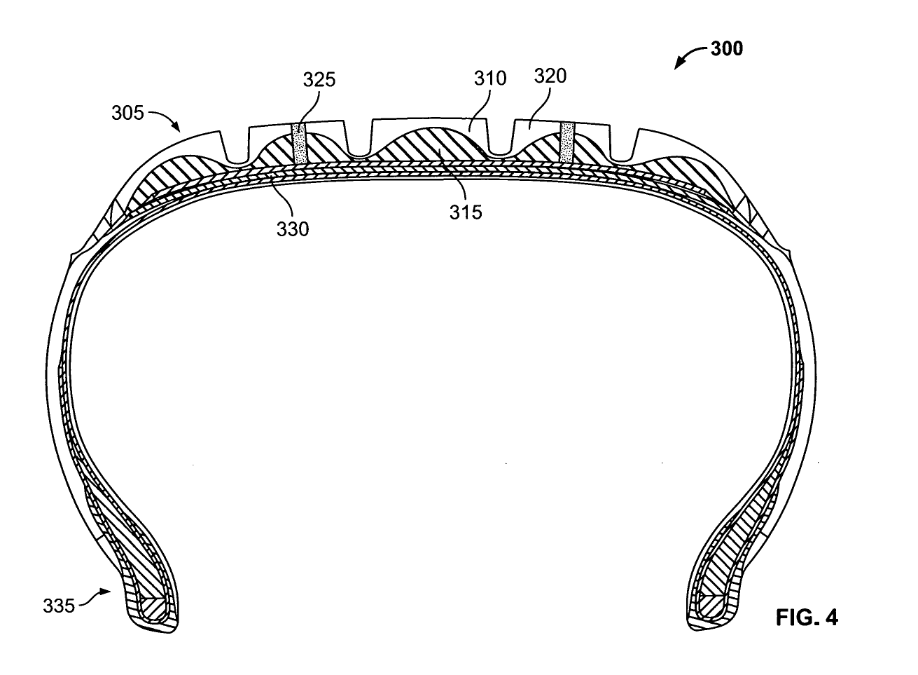

FIG. 4 is a partial cross-section of another alternative embodiment of a tire 300 having a multi-layered tread 305. The tire 300 is substantially the same as the tire 100 of FIGS. 1 and 2 and the tire 200 of FIG. 3 (including the alternative embodiments described), except for the differences discussed herein.

The tread 305 includes a plurality of ribs 310, with each rib including a base layer 315 and a cap layer 320. The base layer 315 and cap layer 320 are substantially the same as the base layer 160 and cap layer 165 (and the base layer 215 and cap layer 220) discussed above.

In this embodiment, the base layer 315 is a single base layer extending across the entire width of the tread 305. The base layer 315 has a wave shape, with rounded peaks and valleys. The base layer 315 does not extend to the surface of the tread 305 when the tire is new. In an alternative embodiment (not shown), the base layer may extend to the surface of the tread at some locations. In another alternative embodiment (not shown), the base layer may be constructed of multiple discrete base layers that are axially spaced apart.

The tread further includes a pair of antennae 325 that are axially spaced from each other. The antennae 325 are constructed of a third material having an electrical resistivity lower than an electrical resistivity of the base layer 315 and lower than an electrical resistivity of the cap layer 320. Exemplary materials for the antennae include, without limitation, natural rubber, synthetic rubber, conductive carbon black, plasticizers, and oil. Alternatively, other materials may be employed. For example, any material having an electrical resistivity less than 1×10⁹ ohm-cm may be used as an antenna.

In one embodiment, the antennae 325 have a complex dynamic modulus that is lower than that of the cap layer 320 and the base layer 315. Alternatively, the antennae may have a complex dynamic modulus that is higher than that of the cap layer, but lower than that of the base layer. In another alternative embodiment, the antennae have a complex dynamic modulus that is higher than that of the cap layer and the base layer.

In one embodiment, the antennae 325 have glass transition temperature that is lower than that of the cap layer 320 and the base layer 315. Alternatively, the antennae may have a glass transition temperature that is lower than that of the cap layer, but higher than that of the base layer. In another alternative embodiment, the antennae have a glass transition temperature that is higher than that of the cap layer and the base layer.

In the illustrated embodiment, the antennae 325 extend to the belts 330. The belts 330 also have a low electrical resistivity. At least a portion of tire material extending from the belts 330 to a bead region 335 also has a low electrical resistivity. Thus, the antennae 325 form a portion of an electrical pathway from the bead region 335 to a surface of the tread 305. The electrical pathway allows static electricity to be discharged to the ground, rather than build up in the tire 300.

Each antenna 325 has a rectangular cross-section. However, other geometric shapes may be employed. In an alternative embodiment (not shown), three or more antennas may be employed. In another alternative embodiment (not shown), only a single antenna is employed.

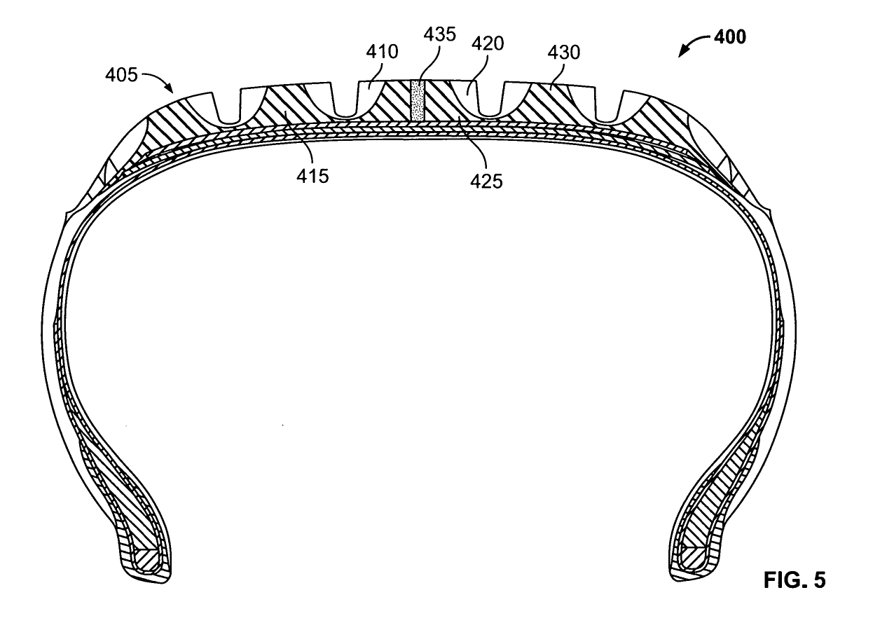

FIG. 5 is a partial cross-section of yet another alternative embodiment of a tire 400 having a multi-layered tread 405. The tire 400 is substantially the same as the tire 100 of FIGS. 1 and 2, the tire 200 of FIG. 3, and the tire 300 of FIG. 4 (including the alternative embodiments described), except for the differences discussed herein.

The tread 405 includes a plurality of ribs 410, with each rib including a base layer 415 and a cap layer 420. The base layer 415 and cap layer 320 are substantially the same as the base layer 160 and cap layer 165 (and the base layers 215, 315 and cap layers 220, 320) discussed above.

In this embodiment, the base layer 415 includes a single base 425 that extends across the entire width of the tread 405. Multiple radial projections 430 extend outwards from the single base 425. In the illustrated embodiment, each rib 410 includes a single projection 430 of the base layer 415 that extends to the surface of the tread 405 when the tire 400 is new. In an alternative embodiment (not shown), the base layer does not extend to the surface of the tread in at least some of the ribs. In another alternative embodiment (not shown), the base layer may be constructed of multiple discrete base layers that are axially spaced apart.

The tread further includes an antenna 435 that is substantially the same as each of the antennae 325 of the tire 300 discussed above, including the alternative embodiments. The antenna 435 forms a conductive pathway in the same manner described above. While the tire 400 is depicted as having a single antenna, in alternative embodiments, multiple antennae may be employed.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modem Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative system and method, and illustrative examples shown and described. Accordingly, departures may be made from such details without departing from the spirit or scope of the applicant's general inventive concept.

What is claimed is:

1. A tire comprising:
a tread having a plurality of grooves, the tread including a base layer and a cap layer disposed above the base layer,
wherein the base layer is constructed of a first rubber composition having a first complex dynamic modulus,
wherein the cap layer is constructed of a second rubber composition having a second complex dynamic modulus greater than the first complex dynamic modulus,
wherein the base layer has a shaped geometry with a bottom portion that is wider than a top portion,
wherein a portion of the base layer is exposed when the tire is new, such that:
$$\frac{{S}_{1}}{{S}_{2}} > 0$$
where S₁ is a surface area of the first rubber composition, and
S₂ is a surface area of the second rubber composition, and
wherein,
$$\frac{{S}_{1}}{{S}_{2}}$$
increases as tne treaa wears.

2. The tire of claim 1, further comprising a pair of bead portions and a pair of sidewall portions extending between the pair of bead portions and the tread.

3. The tire of claim 1, wherein the first rubber composition has a lower glass transition temperature than the second rubber composition.

4. The tire of claim 1, wherein the first rubber composition has a first color and the second rubber composition has a second color different from the first color.

5. The tire of claim 1, wherein the first rubber composition has a first reflectivity when wet and the second rubber composition has a second reflectivity when wet that is different from the first reflectivity.

6. The tire of claim 1, wherein the first rubber composition includes at least one of natural rubber, synthetic rubber, carbon black, plasticizers, and oil.

7. The tire of claim 1, wherein the second rubber composition includes at least one of natural rubber, synthetic rubber, carbon black, silica, and silane.

8. A tire comprising:
a circumferential tread having a base layer and a cap layer disposed above the base layer,
wherein the base layer is constructed of a first material having a first complex dynamic modulus and a first glass transition temperature,
wherein the cap layer is constructed of a second material having a second complex dynamic modulus greater than the first complex dynamic modulus, and a second glass transition temperature higher than the first glass transition temperature,
wherein the base layer has a shaped geometry with a bottom portion that is wider than a top portion, such that an exposed surface area of the first material increases as the circumferential tread wears.

9. The tire of claim 8, wherein the tire is a pneumatic tire further comprising:
a first bead portion;
a first sidewall extending from the first bead portion to the circumferential tread;
a second bead portion; and
a second sidewall extending from the second bead portion to the circumferential tread.

10. The tire of claim 8, wherein a portion of the base layer is exposed when the tire is new.

11. The tire of claim 8, wherein the circumferential tread further includes at least one antenna, the at least one antenna being constructed of a third material having an electrical resistivity lower than an electrical resistivity of the first material and lower than an electrical resistivity of the second material.

12. The tire of claim 11, wherein the antenna has a rectangular cross-section.

13. The tire of claim 8, wherein the base layer includes a plurality of base layers axially spaced from each other.

14. The tire of claim 8, wherein the base layer includes a single base and a plurality of radial projections.

15. A tire tread comprising:
a base layer constructed of a first material having a first complex dynamic modulus, a first glass transition temperature, and a first resistivity;
a cap layer constructed of a second material having a second complex dynamic modulus, a second glass transition temperature, and a second resistivity; and
at least one antenna constructed of a third material having a third complex dynamic modulus, a third glass transition temperature, and a third resistivity,
wherein the first complex dynamic modulus is less than the second complex dynamic modulus,
wherein the first glass transition temperature is lower than the second glass transition temperature,
wherein the first resistivity is higher than the third resistivity, and
wherein the second resistivity is higher than the third resistivity.

16. The tire tread of claim 15, wherein the first complex dynamic modulus is less than the third complex dynamic modulus.

17. The tire tread of claim 15, wherein the first glass transition temperature is lower than the third glass transition temperature.

18. The tire tread of claim 15, wherein the base layer has a bottom portion that is wider than a top portion.

19. The tire tread of claim 15, wherein the base layer is exposed when the tire tread is new.

20. The tire tread of claim 15, wherein the at least one antenna includes a first antenna axially spaced from a second antenna.
